(19) United States
(12) Patent Application Publication
(10) Pub. No.: US 2026/0228224 A1
(43) Pub. Date: Aug. 6, 2026

(54) DATABASE SYSTEMS AND CONSTRAINT MANAGEMENT METHODS USING VIRTUAL CONTAINERS

(71) Applicant: Salesforce, Inc., San Francisco, CA (US)

(72) Inventor: Shaowei Mao, Bellevue, WA (US)

(73) Assignee: Salesforce, Inc., San Francisco, CA (US)

(21) Appl. No.: 19/043,164

(22) Filed: Jan. 31, 2025

(51) Int. Cl. G06F 16/2455; G06F 9/455; G06F 16/23; G06F 16/248

(52) U.S. Cl. CPC G06F 16/24565; G06F 9/45558; G06F 16/2379; G06F 16/248; G06F 2009/45583; G06F 2009/45595

(57) ABSTRACT

Database systems and methods are provided for managing relationships between records in a database. An exemplary method involves identifying a virtual container for a first record at the database system based on one or more fields of the first record and updating the virtual container to associate the first record with one or more additional records. In response to an operation with respect to at least one of the records, the method detects a violation of a constraint associated with the virtual container based on a relationship between respective values associated with the respective records, updates a second field of the first record to include an indication of the constraint, and generates a graphical representation of the first record that includes a graphical indication of the first constraint based at least in part on the second field of the first record.

### TECHNICAL FIELD

One or more implementations relate to the field of database systems, and more specifically, to managing constraints or relationships across different types of records at a database system when configuring custom heterogenous groupings of different types of records.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In a CRM setting or other business context, different combinations or bundles of products or services are typically offered or utilized to build customers, increase revenue, and provide predictable growth and income streams. However, the underlying workflows, validation rules and other functionality supported by the application platform may be inflexible or limit a developer or organization from achieving the full range of customizations and combinations of different products or services that can be grouped or bundled together with the desired level of complexity and/or flexibility, such as, for example, add-ons, renewals, amendments, and/or the like. Additionally, it may be challenging to apply constraints, restrictions or other business logic across different heterogeneous and complex combinations of products and services to ensure compatibility and alignment with marketing strategies, development strategies or other objectives without configuration errors or reliance on complex queries or other operations that can increase latency, coding requirements, and/or the like. Accordingly, it is desirable to provide a flexible service capable of accommodating various customizations and combinations of different types of database records while applying desired constraints across those different heterogeneous and complex combinations of database records in a manner that mitigates configuration errors and improves user experiences.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system that includes a constraint management service associated with a virtual application provided by an application platform at a database system according to some example implementations;

FIG. 2 depicts constraint modeling language (CML) code for a virtual container suitable for use with the constraint management service in the computing system of FIG. 1 according to some example implementations;

FIGS. 3-4 depict graphical user interface (GUI) displays suitable for presentation by an instance of the virtual application in connection with the constraint management service in the computing system of FIG. 1 according to some example implementations;

FIG. 5 is a flow diagram illustrating a constraint management process suitable for implementation by the constraint management service in the computing system of FIG. 1 according to some example implementations;

FIG. 6A is a block diagram illustrating an electronic device according to some example implementations; and

FIG. 6B is a block diagram of a deployment environment according to some example implementations.

### DETAILED DESCRIPTION

The following description describes implementations for applying constraints or rules across user-configurable and customizable groups, bundles or other combinations of different types of database objects or records supported by an application platform and/or a database system at different scopes or across different relationships between those objects or records associated with a particular group. For example, in the context of a virtual customer relationship management (CRM) application provided by an application platform of a database system, a particular user, organization or tenant of the database system may sell multiple different types of products (each of which may have different database object types or records associated therewith) that can be grouped, packaged or otherwise combined (e.g., as part of an order or subscription, to generate a quote or invoice, and/or the like), where that tenant may desire to enforce rules or other constraints based on different attributes of the product(s) being combined at different scopes, which may vary from other tenants and/or depending on the types of product(s) involved. For example, software as a service (SaaS) products (corresponding to different database records or object types) may be provisioned on different tenants, where different “require,” “exclude,” and/or other business logic or rules are to be enforced for products associated with the same tenant to ensure compatibility or interoperability, alignment to marketing and/or sales strategies, and/or the like. At the same time, the products may be associated with or otherwise belong to different database records or object types (e.g., accounts, contacts, opportunities, and/or the like), where there are different “require” and/or “exclude” rules are to be enforced for products associated with the same account.

As described in greater detail below, one or more virtual containers are created that allow database objects or records to be allocated to different virtual containers to allow for different rules or constraints to be enforced based on different attributes of the respective database objects or records at different scopes, without requiring complex queries, searches, or other more complex database operations at run-time. In exemplary implementations, when a group of records is defined, created or otherwise configured at a database system, one or more virtual containers for the respective records are identified based on the values or other attributes of one or more fields of the respective records. The respective virtual containers are updated to associate a respective record with one or more additional records at the database system, and in response to an operation with respect to a field of the respective record, a constraint management service automatically detects or otherwise identifies a violation of a constraint associated with the virtual container based at least in part on a relationship between the value of the field of the record and one or more respective values for that field of one or more additional records associated with the respective virtual container. When violation of a constraint is detected, another field of the record is updated to include an indication of the constraint at the database system and utilized to generate or otherwise provide a graphical indication of a configuration error identifying the constraint that was violated in connection with a graphical representation of the record, thereby allowing a user to modify the definition or configuration of the record to satisfy the constraint and resolve the configuration error.

For example, for purposes of explanation, the subject matter is primarily described herein in the context of an instance of a virtual CRM application incorporating a service configurable to provide a product configurator, configure price quote (CPQ) tool or similar feature capable of generating quotes or perform other actions with respect to user-configurable or customizable combinations of products and services with varying degrees of complexity. In this regard, a user may select or otherwise configure different types of database objects or records corresponding to the respective products or services to be added to a particular quote, order, invoice or the like based on customer requirements. To apply constraints with respect to pricing, discounts, product bundling, upselling, cross-selling, dependencies and/or the like, the virtual CRM application incorporates or otherwise utilizes a constraint management service that identifies the appropriate virtual containers for associating the respective records belonging to a particular quote based on their respective attributes (e.g., type of product or service, number of product or service, and/or the like) and updates the virtual containers to maintain the desired associations between records, which could belong to the same quote or be associated with a different quote. Thereafter, in response to a user modifying or configuring a value for a particular field of a record or a create, read, update, and delete (CRUD) operation with respect to the record(s) belonging to the quote, the constraint management service utilizes the virtual containers to apply the respective rules, constraints or other business logic defined for the respective virtual container to the associated records to automatically detect or otherwise identify a violation of a constraint based on a relationship between the field value(s) or attribute(s) for a particular record belonging to the quote with respect to the field value(s) or attribute(s) for another record associated with that virtual container (which itself could belong to the same or different quote). In this manner, constraints may be applied across different types of records and/or across different quotes or orders.

When the constraint management service detects the violation of a constraint, the constraint management service automatically updates one or more fields of the records associated with the quote to include information or other indicia of the violated constraint, which, in turn, is utilized by the instance of the virtual CRM application to provide a corresponding graphical indication of the violated constraint to the user. In this manner, a user utilizing the product configurator, CPQ tool or similar feature of the virtual CRM application may identify the particular combination or configuration of products and/or services associated with the quote that violate constraints and how or why the constraints are violated, thereby allowing the user to modify the configuration of one or more of the products and/or services associated with the quote to satisfy the constraints.

By virtue of the subject matter described herein, rules, business logic or other constraints can be defined and applied across relationships between different database objects or records associated with a particular group or across different groups, without reliance on complex workflows, validation rules, queries or other database operations. Rather, the constraint management service utilizes a constraint management language (CML) to define a product model and define the hierarchical relationships between different database objects or records and their respective attributes. In exemplary implementations, the CML utilizes object-oriented modeling using a type entity, which represents a virtual container prototype of an entity to be defined by its attributes (integer numbers, decimal numbers, strings or text values, and Boolean logic values), relationships to other type entities (or ports), and corresponding constraints. For example, a quote or product type entity may be defined that includes a number of different child type entities using a port declaration to implement a “has a” relationship or otherwise define that constituent products or services to be associated with the quote. To define constraints to the quote or product type entity, the port declaration may incorporate cardinality to define the minimum and/or maximum number of child type entities required to be associated with the respective quote or product type entity, while attribute declarations may similarly constrained by minimum and/or maximum values. In this manner, virtual containers for each child product or service to be added to a quote may be defined with particular attributes (and corresponding constraints) and potentially ports or relationships to additional child type entities. Thereafter, a top-level virtual container for the quote may be defined with particular attributes (and corresponding constraints) along with different ports (and corresponding constraints) that define what child products or services are required to be included with the particular quote, the particular number of a particular type of child product or service is required to be included with the particular quote, and/or other constraints on the child products or services required to be included with the particular quote based on the respective attributes or configuration of other child products or services included with the particular quote. Thus, when a user attempts to configure a quote that does not include the requisite number or combination of child products or services or otherwise includes a configuration of child products or services that is constrained or otherwise prohibited based on the definition of the quote in the CML, a corresponding notification may be provided to the user with graphical indicia of the particular constraints violated and/or the like.

In practice, the virtual containers may be defined and designed in a visual, WYSIWYG, drag and drop, declarative, and low code (or no code) manner via one or more graphical user interface (GUI) displays using user-configurable web components that allow the user to define the respective different entity types, attributes, ports and corresponding constraints to be applied across virtual containers. The precise implementation details associated with such visual, WYSIWYG, drag and drop, declarative, or low code (or no code) designers are not germane to the subject matter and will not be described in detail herein. For reference, some examples of visual, low code (or no code) WYSIWYG design are described in U.S. Pat. Nos. 11,269,668, 11,321,422 and 11,797,638. That said, in other implementations, the virtual containers implemented by the constraint management service may be defined using a suitable integrated development environment or other code editor, which similarly is not germane to the subject matter and will not be described in detail herein.

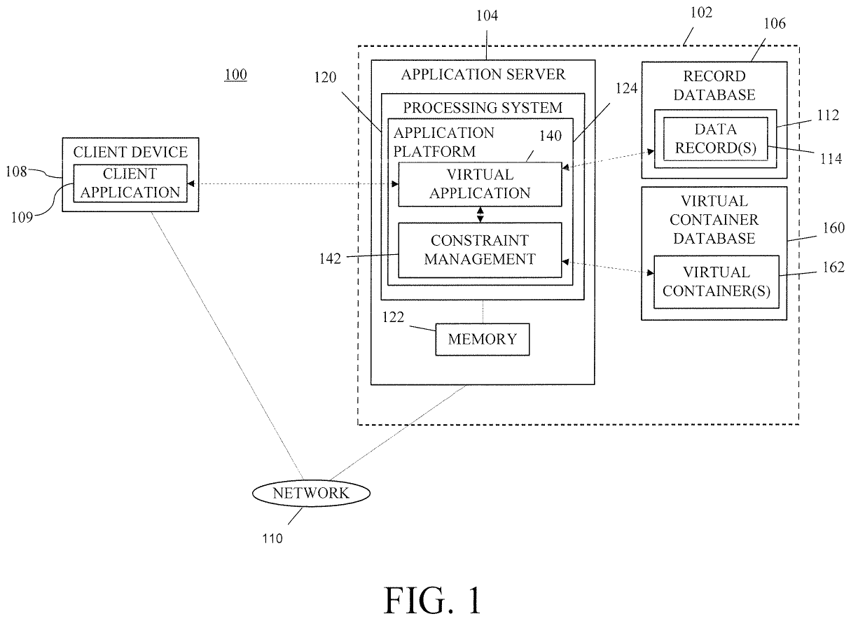

FIG. 1 depicts an exemplary computing system 100 including a database system 102 configurable to provide an application platform 124 capable of concurrently providing instances of one or more virtual applications 140 to client applications 109 at client devices 108 associated with one or more different end users over a communications network 110 (e.g., the Internet or any sort or combination of wired and/or wireless computer network, a cellular network, a mobile broadband network, a radio network, or the like). As described in greater detail below, the application platform 124 at the database system 102 implements, includes or otherwise supports a constraint management service 142 capable of implementing one or more virtual containers 162 for applying constraints across different heterogenous combinations, groupings or other configurations of different types of data records 114 maintained in a record database 106 at the database system 102. That said, it should be appreciated that FIG. 1 is a simplified representation of a computing system 100 and is not intended to be limiting. In this regard, it should be noted that although FIG. 1 depicts a database system 102 including multiple different and distinct databases 106, 160, in practice, one or more of the databases 106, 160 may be integrated or otherwise implemented at a common database. Moreover, in practice, the constraint management service 142 may be implemented independent of the application platform 124 and/or the virtual application 140.

In one or more exemplary implementations, the database system 102 includes one or more application servers 104 that support an application platform 124 capable of providing instances of virtual applications 140, over the network 110, to any number of client devices 108 that users may interact with to view, access or obtain data or other information from one or more data records 114 maintained in one or more data tables 112 at a record database 106 or other repository associated with the database system 102. For example, a record database 106 may maintain, on behalf of a user, tenant, organization or other resource owner, data records 114 entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the record database 106). In this regard, in one or more implementations, the database system 102 is realized as an on-demand multi-tenant database system that is capable of dynamically creating and supporting virtual applications 140 based upon data from a common database 106 that is shared between multiple tenants, which may alternatively be referred to herein as a multi-tenant database. Data and services generated by the virtual applications 140 may be provided via the network 110 to any number of client devices 108, as desired, where instances of the virtual application 140 may be suitably generated at run-time (or on-demand) using a common application platform 124 that securely provides access to the data in the record database 106 for each of the various tenants subscribing to the multi-tenant system.

The application server 104 generally represents the one or more server computing devices, server computing systems or other combination of processing logic, circuitry, hardware, and/or other components configured to support remote access to data records 114 maintained in the data tables 112 at the record database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receivers, transceivers, wired network interface controllers (e.g., an Ethernet adapter), wireless adapters or other suitable network interfaces that support communications to/from the network 110 coupled thereto. The application server 104 also includes or otherwise accesses a data storage element 122 (or memory), which may be realized as a local disk, hard disk, random access memory (RAM), read only memory (ROM), flash memory, magnetic or optical mass storage, or any other suitable non-transitory short or long term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and related software services that are configurable to support the subject matter described herein.

The client device 108 generally represents an electronic device coupled to the network 110 that may be utilized by a user to access an instance of the virtual application 140 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 140. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. Some implementations may support text-to-speech, speech-to-text, or other speech recognition systems, in which case the client device 108 may include a microphone or other audio input device that functions as the user input device, with a speaker or other audio output device capable of functioning as an output device. The illustrated client device 108 executes or otherwise supports a client application 109 that communicates with the application platform 124 provided by the processing system 120 at the application server 104 to access an instance of the virtual application 140 using a networking protocol. In some implementations, the client application 109 is realized as a web browser or similar local client application executed by the client device 108 that contacts the application platform 124 at the application server 104 using a networking protocol, such as hypertext transport protocol secure (HTTPS). In this manner, the client application 109 may be utilized to access or otherwise initiate an instance of a virtual application 140 hosted by the database system 102, where the virtual application 140 provides one or more web page GUI displays within the client application 109 that include GUI elements for interfacing and/or interacting with records 114 maintained at the record database 106.

Still referring to FIG. 1, in exemplary implementations, the record database 106 stores or otherwise maintains data for integration with or invocation by a virtual application 140 in objects organized in object tables 112. In this regard, the record database 106 may include any number of different object tables 112 configured to store or otherwise maintain alphanumeric values or other descriptive information that define a particular instance of a respective type of object associated with a respective object table 112. For example, the virtual application may support a number of different types of objects that may be incorporated into or otherwise depicted or manipulated by the virtual application, with each different type of object having a corresponding object table 112 that includes columns or fields corresponding to the different parameters or criteria that define a particular instance of that object. In some implementations, the record database 106 stores or otherwise maintains application objects (e.g., an application object type) where the application object table 112 includes columns or fields corresponding to the different parameters or criteria that define a particular virtual application 140 capable of being generated or otherwise provided by the application platform 124 on a client device 108. In this regard, the record database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that instance of the virtual application 140.

In exemplary implementations, the record database 106 stores or otherwise maintains additional database objects for association and/or integration with a virtual application 140, which may include custom objects and/or standard objects. For example, in the context of a virtual CRM application, standard database objects may include account, contact, lead, opportunity, quote, invoice, order and/or the like. Additionally, an administrator user associated with a particular resource owner may utilize an instance of a virtual application 140 to create or otherwise define a new custom field to be added to or associated with a standard object, or define a new custom object type that includes one or more new custom fields associated therewith. For example, an administrator user associated with a particular resource owner or tenant may define different custom objects corresponding to the different types of products or services sold or provided by the respective resource owner or tenant, with corresponding custom fields defining attributes of the respective instances of those custom objects. In some implementations, the record database 106 may also maintain metadata that defines or describes the fields, process flows, workflows, formulas, business logic, validation rules, structure and other database components or constructs that may be associated with a particular database object.

In one or more exemplary implementations, the application platform 124 is configurable to facilitate or generate an instance of a virtual application 140 at run-time or on-demand using configured web components associated with the web application that are maintained in a component database coupled to the application server 104. In this regard, the configured web components define the particular fields or parameters of data records 114 to be integrated with, incorporated into or otherwise included in a particular web page GUI display associated with the virtual application 140 for a particular tenant's configuration. For example, a developer of a web application may configure, define or otherwise provide other information for one or more fields of a particular database object type for an instance of a web component template added to a web page GUI display of the virtual application, which, in turn, may be utilized by the application platform 124 and/or a client application 109 to retrieve data from the record database 106 for incorporation within the virtual application 140 by populating or otherwise generating the instance of the configured web component using the retrieved data at run-time or on-demand.

In the illustrated implementation, the database system 102 also includes a virtual container database 160 that stores or otherwise maintains code or files that define or describe the respective virtual containers 162 to be supported by a constraint management service 142 in connection with the virtual application 140. In this regard, depending on the configuration, the virtual containers may be associated with particular resource owners or tenants to limit the scope of the respective constraints defined therein to a particular resource owner or tenant, or alternatively, the virtual containers may be associated with particular types of standard database objects supported by the virtual application 140 or otherwise configured to apply constraints across multiple different resource owners or tenants. As described above, the virtual containers 162 may be defined using a constraint modeling language (CML) that allows for a user to define hierarchical relationships between different types of entities, the respective attributes associated with those different types of entities, the respective relationships or associations between different types of entities, and any constraints to be applied with respect to the attributes and/or associative relationships between different types of entities. In practice, the code, file or other information defining a particular virtual container 162 may be stored or otherwise maintained in the virtual container database 160 along with information identifying the particular tenant and/or database objects to which the particular virtual container 162 applies. In this regard, the constraint management service 142 is configurable to map or otherwise identify the particular virtual containers 162 associated with particular instances of data records 114 in the record database 106 at the database system 102 to identify which virtual containers 162 are to be applied with respect to a particular data record 114 in response to a CRUD operation or other interaction with a particular data record 114 in the record database 106. For example, an administrator user associated with a particular resource owner or tenant may define a particular virtual container 162 to be applied to quote database objects associated with that particular resource owner or tenant, such that when a user of a client device 108 that is associated with that tenant interacts with a quote data record 114 associated with that tenant, the constraint management service 142 identifies the virtual container 162 defined for quote database objects for that tenant to be applied to the quote data record 114 being interacted with, as described in greater detail below.

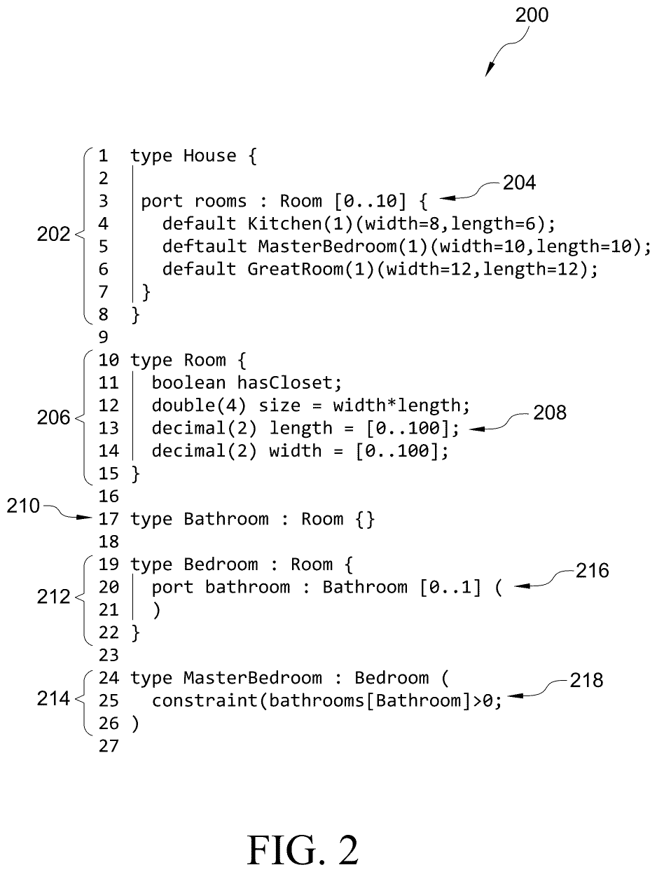

FIG. 2 depicts an exemplary implementation of a virtual container 200 defined using a constraint modeling language (CML) to apply constraints across relationships between different types of data records corresponding to different database object types supported by an application platform and/or virtual application at a database system. For purposes of explanation, FIG. 2 depicts a virtual container 200 defined in CML for a house model; however, it should be appreciated that the subject matter is not limited to any particular type or configuration of product model. The virtual container 200 defines a house type entity 202 that functions as a virtual container prototype for a house product that includes rooms defined by a port 204 to one or more room type entities 206. In this regard, in the illustrated implementation, the port 204 declaration constrains the house type entity to include an associated number of rooms represented by room type entities 206 up to a total maximum number of rooms of 10, and by default, includes at least one kitchen room type entity, a master bedroom room type entity, and a great room room type entity. It should be noted that although FIG. 2 depicts a house type entity 202 defined by port 204, in practice, a top-level product model virtual container may be further defined by additional attributes, ports and constraints.

The room type entity 206 similarly functions as a virtual container prototype for a room subproduct or subcomponent of a house that is defined by attributes 208. The illustrated virtual container 200 also includes child room type entities 210, 212, 214 for bathrooms, bedrooms and master bedrooms which inherit any attributes 208, ports or constraints from the parent room type entity 206 and can extend the parent room type entity 206 with additional ports, constraints or other attributes associated with that respective child type entity 210, 212, 214. For example, the bedroom child room type entity 212 is defined by a port 216 constraining the bedroom to being associated with between zero and one bathroom child room type entity 210, while the master bedroom child room type entity 214 is defined by a constraint 218 requiring the master bedroom to be associated with at least one bathroom child room type entity 210.

Referring to FIG. 2 with reference to FIG. 1, when a user of a client device 108 utilizes a product configurator or CPQ tool of a virtual application 140 to define a quote for a house database object type and corresponding data records 114 associated therewith, the constraint management service 142 analyzes the data records 114 associated with the quote to identify the house virtual container 162, 200 and the different room virtual containers 206, 210, 212, 214 to be associated with the respective data records 114 associated with the quote data record 114. For example, the constraint management service 142 may utilize a field of the quote data record 114 to identify the house data record 114 associated with the quote and then analyzes one or more fields of the house data record 114 to identify the house virtual container 162, 200 for the house data record 114 (e.g., by matching or mapping an identifier for the tenant or other resource owner associated with the data record 114 to an identifier associated with the virtual container 162, 200, matching or mapping a value indicative of a database object type associated with the data record 114 to a database object type associated with the virtual container 162, 202, and/or the like). In a similar manner, the constraint management service 142 utilize fields of the house data record 114 and/or the associated room data records 114 to identify the appropriate room virtual containers 162, 206, 210, 212, 214 for the respective room data records 114 associated with the house data record 114 that was mapped to the virtual containers 200, 202.

After identifying the relevant virtual containers 162 to be associated with the respective data records 114, the constraint management service 142 updates the respective virtual containers 162 to include, incorporate, associate or otherwise reflect the data records 114 mapped to the respective virtual containers 162 to maintain associations between the different data records 114 at the database system 102 using the virtual containers 162. For example, the constraint management service 142 may generate updated CML code for the house product model virtual container 162, 200 to associate the house type entity 202 with the house data record 114 and implement the port relationship 204 with the room type entities 206 that were created or updated to reflect the room data records 114 associated with the house data record 114 with the respective defined attributes for those room data records 114. Thereafter, in response to a CRUD operation or other interaction with the quote data record 114 or a respective house or room data record 114 associated therewith, the constraint management service 142 executes or otherwise implements the updated CML code for the virtual containers 162 to automatically apply the ports or constraints defined therein across the different types of data records 114 associated within the virtual containers 162. For example, the constraint management service 142 may execute the house product model virtual container 162, 200 associated with the quote data record 114 when the user modifies or configures the quote to verify that the quote includes at least one house (and corresponding house database object type data record 114), that that house includes between zero and ten rooms, that those associated rooms include at least one kitchen, master bedroom and great room (and corresponding database object type data records 114), that each of the associated rooms has defined dimensions or size attributes, that any bedrooms are associated with either zero or one bathrooms, and that the master bedroom includes at least one bathroom associated therewith. In response to detecting a violation of a constraint associated with the attributes, ports or other constraints of one or more of the virtual containers 162, the constraint management service 142 provides a corresponding indication of the violation to the virtual application 140 to automatically update one or more fields of the quote, house and/or room data record(s) 114 to identify the particular constraint that was validated. In response the virtual application 140 may automatically update a GUI display associated with the product configurator or CPQ tool to generate a graphical representation of the particular data record 114 that violated a constraint along with a graphical indication of the constraint that was violated based on values for one or more fields of the respective data record 114.

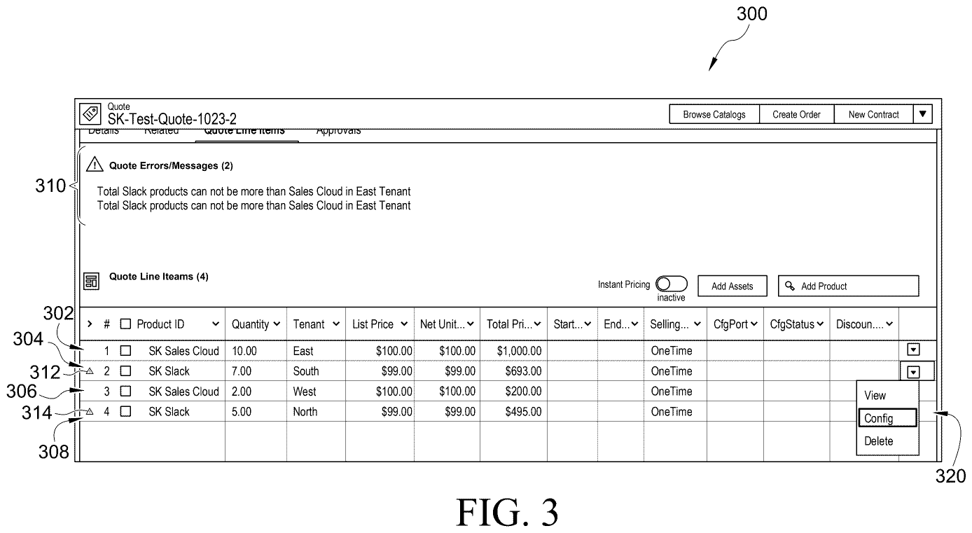

FIG. 3 depicts an exemplary implementation of a quote configuration GUI display 300 suitable for presentation by an instance of a virtual application 140 in connection with a product configurator, CPQ tool or other feature of the virtual application 140. The quote configuration GUI display 300 includes a graphical representation of a quote data record 114 including graphical representations 302, 304, 306, 308 of the respective product data records 114 associated with the quote data record 114 capable of being created, defined or otherwise configured via the quote configuration GUI display 300. FIG. 3 depicts a state of the quote configuration GUI display 300 after user interaction with one or more of the product data records 114 that caused the constraint management service 142 to execute or otherwise implement one or more virtual containers 162 associated with the quote or the products associated therewith to detect violation of one or more constraints on relationships between the different product data records 114 associated with the quote. For example, in the illustrated implementation, the constraint management service 142 detects violation of a constraint associated with a virtual container 162 for the quote data record 114 that limits the number of data records 114 of a first product database object type (“Slack”) that can be associated with the quote based on the number of data records 114 of a second product database object type (“Sales Cloud”) associated with a particular tenant or resource owner (“East Tenant”). As shown, the constraint management service 142 provides a corresponding indication of the violated constraint to the virtual application 140 and/or updates a field of the data records 114 of the first product database object type to include indication of the violated constraint associated with those data records 114. In response, the virtual application 140 generates or otherwise provides graphical indicia 310, 312, 314 of the violated constraint in connection with the respective graphical representations of those data records 114 of the first product database object type violating the constraint.

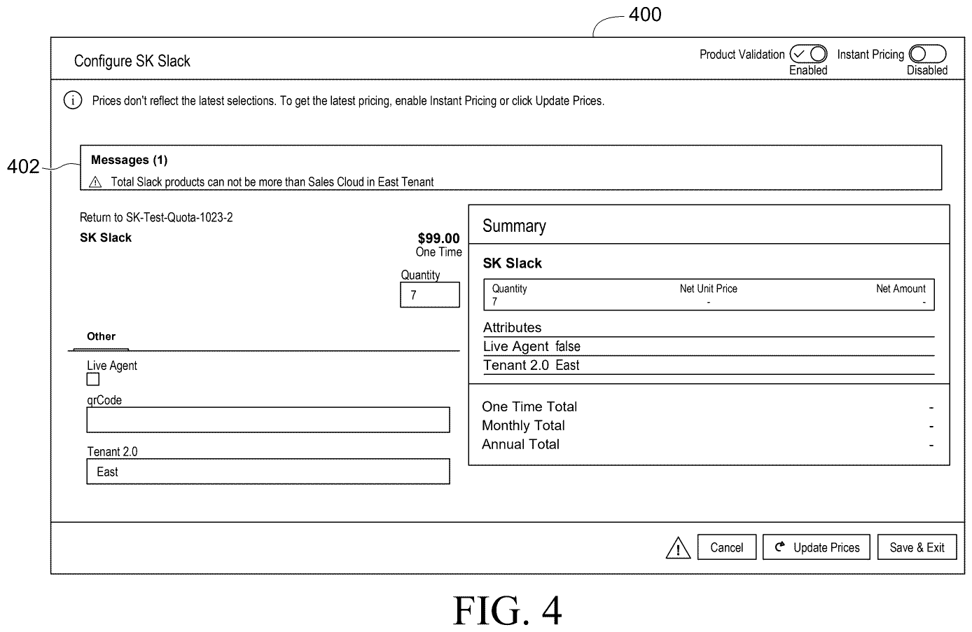

Referring to FIG. 4 with reference to FIG. 3, in exemplary implementations, the quote configuration GUI display 300 includes a GUI element 320 manipulable by a user to modify the configuration of a respective product data record 114 that causes the virtual application 140 to generate a product configuration GUI display 400 that includes a graphical representation of the data record 114 of the first product database object type. The product configuration GUI display 400 includes a graphical indication 402 of the constraint associated with the virtual container 162 violated the values for one or more fields of the respective product data record 114 along with one or more GUI elements manipulable by the user to modify the value for one or more fields of the respective product data record 114 (e.g., the quantity value, the associated tenant and/or the like) to cause the attributes of the product to satisfy the constraint associated with the virtual container 162. In response to user interaction with a GUI element to modify the value of a field of the product data record 114 or otherwise modify the configuration of the product, the constraint management service 142 automatically updates and executes the virtual containers 162 associated with the product and/or quote using the modified value(s) for the attribute(s) of the corresponding product entity corresponding to the respective updated value(s) for the field(s) of the product data record 114 to verify or otherwise confirm that the constraints associated with the virtual containers 162 are satisfied. In response to determining a previously violated constraint has been satisfied, the constraint management service 142 provides a corresponding indication to the virtual application 140 and/or updates a field of the data record 114 to delete or otherwise remove any indication of a previously-violated constraint associated with the data record 114 to cause the virtual application 140 to remove the relevant graphical indicia 310, 312, 402 of the violated constraint from the respective GUI displays 300, 400 associated with the virtual application 140.

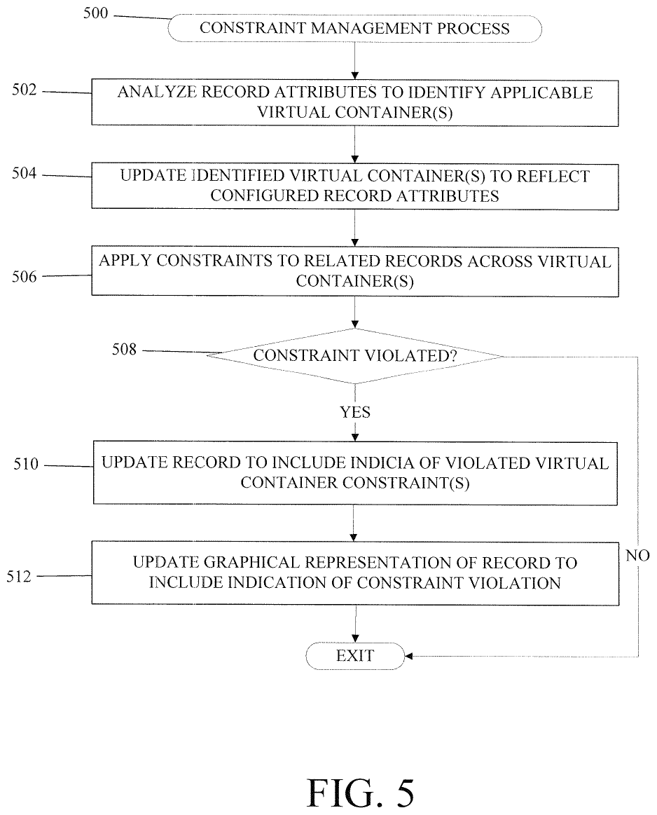

FIG. 5 depicts an exemplary constraint management process 500 suitable for implementation by a constraint management service associated with an application platform to apply constraints across different types of database objects or records at a database system using virtual containers and perform additional tasks, functions, and/or operations described herein. For illustrative purposes, the following description may refer to elements mentioned above in connection with FIGS. 1-4. It should be appreciated that the constraint management process 500 may include any number of additional or alternative tasks, the tasks need not be performed in the illustrated order and/or the tasks may be performed concurrently, and/or the constraint management process 500 may be incorporated into a more comprehensive procedure or process having additional functionality not described in detail herein. Moreover, one or more of the tasks shown and described in the context of FIG. 5 could be omitted from a practical implementation of the constraint management process 500 as long as the intended overall functionality remains intact.

Referring to FIG. 5, with continued reference to FIGS. 1-4, in exemplary implementations, the constraint management process 500 is initiated or otherwise performed in response to user interaction with an instance of a virtual application to perform a CRUD operation with respect to one or more data records at a database system. In this regard, the constraint management process 500 may be initiated by a product configurator, CPQ tool or other software component or feature of an instance of a virtual application 140 in response to user interaction to create, update or otherwise modify one or more configurations, relationships or values associated with one or more data records 114 at the database system 102. For example, a CPQ tool may trigger, invoke or otherwise initiate the constraint management service 142 supporting the constraint management process 500 in response to user selection of a GUI element of a quote configuration GUI display 300 or a product configuration GUI display 400 to modify the values or configurations of one or more data records 114 corresponding to different products associated with a quote.

The constraint management process 500 analyzes record attributes to identify any applicable virtual containers corresponding to the records being interacted with and automatically updates the identified virtual containers to reflect the current state of the records (tasks 502, 504). For example, in response to a user interacting with a GUI display 300, 400 provided by the virtual application 140 to create a quote (e.g., by defining one or more products for the quote) or modifying the configuration or values of one or more products associated with an existing quote, the instance of the virtual application 140 provides corresponding indicia of the data records 114 for the respective quote and products to the constraint management service 142, which, in turn, analyzes the values for the various fields of the different types of data records 114 associated with the quote to identify applicable virtual containers 162 defined for those data records 114. In this regard, the constraint management service 142 may analyze values for one or more fields of the quote data record 114 to identify a virtual container 162 applicable to that quote data record 114 (e.g., by mapping the combination of the database object type and tenant identifier associated with the quote data record 114 to a corresponding virtual container 162) and automatically updates the virtual container 162 to reflect the values for one or more fields of the quote data record 114. For example, the constraint management service 142 may instantiate a quote virtual container object corresponding to the identified virtual container 162 using values for attributes obtained from one or more fields of the quote data record 114.

In a similar manner, for the different types of database objects and corresponding data records 114 associated with that quote data record 114, the constraint management service 142 identifies applicable virtual containers 162 for those types of data records 114 and instantiates one or more virtual container objects corresponding to the identified virtual containers 162 using values for attributes obtained from one or more fields of the respective data records 114. In this regard, in addition to creating a quote type entity representative of the quote data record 114, the constraint management service 142 creates different product type entities representative of the different types of data records 114 associated with the quote data record 114 with the respective associations or relationships defined by the respective fields of the data records 114.

After identifying and mapping the different data records to corresponding virtual container objects, the constraint management process 500 automatically applies constraints to the group of related records across the virtual containers to detect or otherwise identify when the values for one or more fields of the records violates a constraint associated with a virtual container (task 506, 508). For example, after creating the virtual container objects, the constraint management service 142 may execute the CML or other code of the respective virtual container objects to verify that the virtual container objects include the required type, number and/or configuration of ports, attributes or other constraints with respect to one another. For example, the constraint management service 142 may verify a quote associated with a particular tenant includes a particular number or combination of different types of products defined as a part of a rule or other business logic for that particular tenant, and further verify that those of different types of products have the required attributes, ports, associations or relationships, and/or the like that have been defined based on the rules or business logic defined by or for that particular tenant.

When the value for a particular field of a data record causes its corresponding virtual container object representation to violate a constraint associated with that virtual container, the constraint management process 500 automatically updates that data record to include an indication of the violated constraint(s) associated with the virtual container and automatically updates a graphical representation of the data record to include graphical indication of the constraint violation (tasks 512, 514). For example, as described above in the context of FIGS. 3-4, in response to detecting that a value for a quantity field of a product data record violates a constraint on the attribute for the quantity field based on the current configuration of a different type of product data record associated with the quote, the constraint management service 142 may provide a corresponding indication to the virtual application 140 to update a field of the product data record and/or a field of the quote data record to include a string, text, value or other information identifying the particular constraint that was violated with respect to the configuration of that particular product data record. After updating a respective data record 114, the instance of the virtual application 140 may automatically and dynamically update the GUI display associated with the virtual application 140 to reflect the updated value for that field indicating the constraint violation, for example, by automatically generating a graphical representation 310 of the string or text value of the field of the violating product data record 114 and/or automatically providing a graphical indication 312 proximate to or in visual association with the graphical representation 304 of that violating product data record 114.

In this manner, after the constraint management process 500 provides substantially real-time feedback to the user of the particular constraints violated with respect to potentially complex combinations of different types of data records 114 corresponding to different database object types grouped together or otherwise associated with a common quote in a manner that allows the user to modify the configuration of the data records 114 to resolve the constraint without requiring performance of complex queries or other operations on the data records 114 at the database system 102 to apply different constraints across heterogenous combinations of data records 114. Thus, a user using a CPQ tool, product configurator or other feature of the virtual application 140 may ensure the resulting configuration of different combinations of different types of products or services satisfy or otherwise comply with any sort of set of rules or business logic associated with that user's associated tenant, with varying levels of scope and/or complexity, and thereby align with the tenant's marketing strategies, development strategies or other CRM objectives.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as services) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

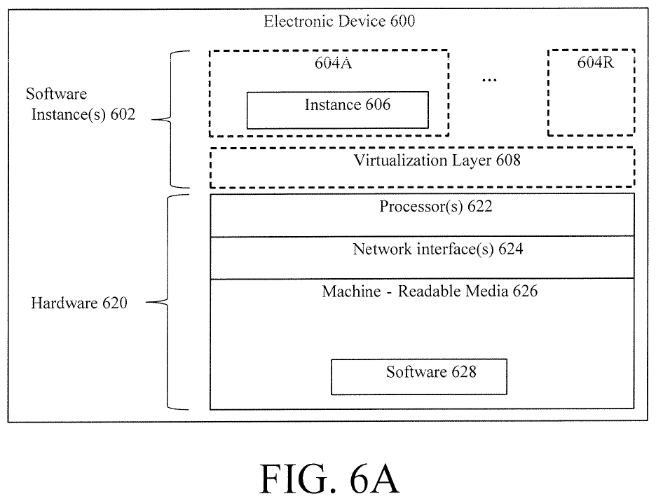

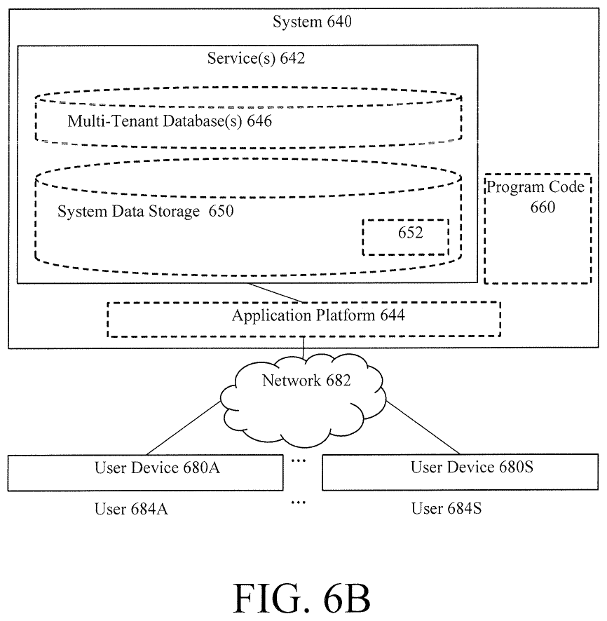

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 626 may include non-transitory and/or transitory machine-readable media. Each of the previously described applications and related services may be implemented in one or more electronic devices 600. In one implementation: 1) each of the clients is implemented in a separate one of the electronic devices 600 (e.g., in end user devices where the software 628 represents the software to implement clients to interface directly and/or indirectly with the virtual application and/or constraint management service(e.g., software 628 represents a web browser, a native client, a portal, a command-line interface, and/or an application programming interface (API) based upon protocols such as Simple Object Access Protocol (SOAP), Representational State Transfer (REST), etc.)); 2) the virtual application and/or constraint management service is implemented in a separate set of one or more of the electronic devices 600 (e.g., a set of one or more server devices where the software 628 represents the software to implement the virtual application and/or constraint management service); and 3) in operation, the electronic devices implementing the clients and the virtual application and/or constraint management service would be communicatively coupled (e.g., by a network) and would establish between them (or through one or more other layers and/or or other services) connections for submitting requests to the virtual application and/or constraint management service. Other configurations of electronic devices may be used in other implementations (e.g., an implementation in which the client and the virtual application and/or constraint management service are implemented on a single one of electronic device 600).

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-604R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-604R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-604R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-604R if implemented, are collectively referred to as software instance(s) 602.

Alternative implementations of an electronic device may have numerous variations from that described above. For example, customized hardware and/or accelerators might also be used in an electronic device.

FIG. 6B is a block diagram of a deployment environment according to some example implementations. A system 640 includes hardware (e.g., a set of one or more server devices) and software to provide service(s) 642, including one or more services configurable to support a virtual application and/or a constraint management service. In some implementations the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 640 is coupled to user devices 680A-680S over a network 682. The service(s) 642 may be on-demand services that are made available to one or more of the users 684A-684S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-684S). The service(s) 642 may communicate with each other and/or with one or more of the user devices 680A-680S via one or more APIs (e.g., a REST API). In some implementations, the user devices 680A-680S are operated by users 684A-684S, and each may be operated as a client device and/or a server device. In some implementations, one or more of the user devices 680A-680S are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors'data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 640 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 640 may include an application platform 644 that enables PAAS for creating, managing, and executing one or more applications developed by the provider of the application platform 644, users accessing the system 640 via one or more of user devices 680A-680S, or third-party application developers accessing the system 640 via one or more of user devices 680A-680S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user devices 680A-680S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the multi-tenant database(s) 646 and/or system data storage 650.

In some implementations, the service(s) 642 are implemented using virtual applications dynamically created at run time responsive to queries from the user devices 680A-680S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 662 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including by the virtual application and/or constraint management service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user devices 680A-680S.

Each user device 680A-680S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684A-684S to interact with various GUI pages that may be presented to the one or more of users 684A-684S. User devices 680A-680S might communicate with system 640 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 680A-680S might include an HTTP client, commonly referred to as a “browser,” for sending and receiving HTTP messages to and from server(s) of system 640, thus allowing users 684A-684S of the user devices 680A-680S to access, process and view information, pages and applications available to it from system 640 over network 682.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method of managing records at a database system, the method comprising:
identifying, at the database system, a virtual container for a first record of a plurality of records at the database system based on one or more fields of the first record;
updating the virtual container to associate the first record with one or more additional records of the plurality of records at the database system; and
in response to an operation with respect to at least one of the first record and the one or more additional records:
detecting a violation of a first constraint associated with the virtual container based at least in part on a relationship between a first value of a respective field of the first record and one or more respective values associated with the one or more additional records; and
updating, at the database system, a second field of the first record to include an indication of the first constraint; and
generating, by the database system, a graphical representation of the first record at a client application at a client device over a network that includes a graphical indication of the first constraint based at least in part on the second field of the first record.

2. The method of claim 1, wherein:
identifying the virtual container comprises identifying the virtual container for a data record based on an identifier associated with the data record; and
updating the virtual container comprises updating a virtual container object corresponding to the data record using values for the one or more fields of the data record to associate the virtual container object with one or more additional virtual container objects associated with one or more additional data records at the database system.

3. The method of claim 2, wherein detecting the violation comprises detecting the violation when at least one of the first value and the one or more respective values violates a threshold associated with the relationship between the first value and the one or more respective values.

4. The method of claim 3, wherein detection the violation comprises detecting the violation when a number of the one or more additional virtual container objects violates a threshold number of additional data records associated with the data record.

5. The method of claim 3, wherein detection the violation comprises detecting the violation when a type of the one or more additional virtual container objects false to satisfy a constrained type of additional data record to be associated with the data record.

6. The method of claim 1, wherein:
updating the second field comprises updating the second field to include a text value describing the first constraint; and
generating the graphical representation comprises updating a graphical user interface (GUI) display including the graphical representation of the first record to include a graphical representation of the text value of the second field of the first record.

7. The method of claim 1, wherein:
identifying the virtual container comprises identifying a product type virtual container object corresponding to the first record based at least in part on a first field of the first record indicative of a database object type associated with the first record; and
updating the virtual container to associate the first record with the one or more additional records of the plurality of records at the database system comprises updating the product type virtual container object to include attributes from one or more additional fields of the first record to associate the product type virtual container object with a quote type virtual container object corresponding to a second record of the one or more additional records.

8. The method of claim 7, wherein detecting the violation comprises detecting the first value for the respective field of the first record violates a threshold number for the respective field, wherein the threshold number is based on the one or more respective values of the quote type virtual container object.

9. The method of claim 8, wherein updating the second field of the first record comprises updating the second field of the first record to include text indicative of the threshold number for the respective field.

10. The method of claim 9, wherein generating the graphical representation comprises generating a quote configuration graphical user interface (GUI) display including the graphical representation of the first record and a graphical representation of the text indicative of the threshold number for the respective field of the first record.

11. The method of claim 1, wherein updating the virtual container to associate the first record with the one or more additional records of the plurality of records at the database system comprises updating the virtual container using respective values for respective fields of the first record to define a hierarchical relationship between the first record and the one or more additional records.

12. The method of claim 11, wherein detecting the violation of the first constraint comprises detecting an absence of a required hierarchical relationship between the first record and the one or more additional records.

13. The method of claim 11, wherein detecting the violation of the first constraint comprises detecting a number of the one or more additional records associated with the first record violates a threshold number for the hierarchical relationship.

14. The method of claim 13, wherein respective database object types associated with the one or more additional records are different from a first database object type associated with the first record.

15. A non-transitory machine-readable storage medium that provides instructions that, when executed by a processor, are configurable to cause the processor to perform operations comprising:
providing a graphical user interface (GUI) display associated with a virtual application at a client device, the GUI display comprising one or more GUI elements for configuring a relationship between different data records at a database system;
identifying a virtual container for the relationship between the different data records at the database system based on one or more fields of one or more of the different data records;
updating the virtual container to associate different virtual container objects corresponding to the different data records at the database system, the different virtual container objects including respective values corresponding to respective fields of the different data records;
in response to an user interaction with the one or more GUI elements:
detecting a violation of a first constraint associated with the virtual container based at least in part on a relationship between the respective values of the different virtual container objects;
updating a respective field of at least one of the different data records to include indication of the first constraint; and
updating the GUI display to include a graphical representation of the indication of the first constraint associated with a graphical representation of the at least one of the different data records.

16. The non-transitory machine-readable storage medium of claim 15, wherein the instructions are configurable to cause the processor to detect the violation of the first constraint based at least in part on a hierarchical relationship between the different virtual container objects using the respective values.

17. The non-transitory machine-readable storage medium of claim 16, wherein the violation of the first constraint comprises an absence of a particular type of child virtual container object associated with the virtual container.

18. The non-transitory machine-readable storage medium of claim 16, wherein the violation of the first constraint comprises a number of a particular type of the different virtual container objects associated with the virtual container that violates a threshold number for the particular type associated with the virtual container.

19. The non-transitory machine-readable storage medium of claim 15, wherein:
identifying the virtual container comprises identifying a quote virtual container object for the relationship between the different data records at the database system based on a tenant identifier of the one or more fields of the one or more of the different data records;
updating the virtual container comprises updating the quote virtual container object to associate different product virtual container objects corresponding to the different data records at the database system, the different product virtual container objects including respective attributes comprising the respective values corresponding to the respective fields of the different data records; and
detecting the violation comprises detecting the violation of the first constraint associated with the quote virtual container object based at least in part on a relationship between the respective values of the different product virtual container objects in response to the user interaction with the one or more GUI elements to modify one or more of the respective values of the respective fields of the different data records.

20. The non-transitory machine-readable storage medium of claim 19, wherein:
the GUI display comprises a quote configuration GUI display associated with the virtual application; and
updating the GUI display comprises updating the quote configuration GUI display to include the graphical representation of the indication of the first constraint violated by the one or more of the respective values in response to the user interaction.
